(19) United States
(12) Patent Application Publication
(10) Pub. No.: US 2013/0257640 A1
(43) Pub. Date: Oct. 3, 2013

(54) Device for Alerting and Preventing Radar and Laser Measurements

(71) Applicants: Tom Marnix Alexander de Wilde, Hillegom (NL); Patrick Dijkstra, Driebruggen (NL)

(72) Inventors: Tom Marnix Alexander de Wilde, Hillegom (NL); Patrick Dijkstra, Driebruggen (NL)

(21) Appl. No.: 13/689,323

(22) Filed: Nov. 29, 2012

(30) Foreign Application Priority Data
Mar. 28, 2012 (NL) NL 2008556

(51) Int. Cl. G01S 7/02

(52) U.S. Cl. CPC G01S 7/022
USPC 342/20

(57) ABSTRACT

A device for alerting to and/for preventing radar and/or laser measurements, comprising a central processing unit, a radar detection unit and/or a laser detection unit, which is/are connected to the central processing unit, memory for software that can be loaded into the central processing unit, an alerting unit which is connected to the central processing unit, and a location determination unit, such as a GPS unit, which is connected to the central processing unit and can transmit location information to the central processing unit. The central processing unit being designed to deliver an alarm signal, an interference signal and/or another signal upon detection of a radar signal or laser signal, and wherein the central processing unit is designed to change one or more settings of the device in response to the location information.

### RELATED APPLICATION

This application claims priority to Dutch patent application NL 2008556 filed on Mar. 28, 2012, entitled “Device for alerting to and/or preventing radar and/or laser measurements”, the entirety of which is incorporated herein.

### BACKGROUND OF THE INVENTION

1. Field of the Invention

The present invention relates to a device for alerting a user to the presence of a radar or laser signal used by police for measuring speed, or preventing or disrupting a radar or laser speed signal.

2. Description of the Related Art

Current known devices may be comprised of a central processing unit, a radar detection unit and/or a laser detection unit, which are connected to a central processing unit (CPU). The known devices often include memory connected to or part of the CPU. The devices have software which can be loaded into the CPU, an alerting unit connected to the CPU, and a location determination unit, such as a GPS unit, connected to the CPU that can transmit location information to the CPU. The CPU is designed to deliver an alarm signal, an interference signal and/or another signal upon detection of a radar signal or laser signal. The term “laser signal” as used within this context is to be understood to include other optical signals as well.

Such devices are used by drivers of vehicles to prevent speeding, or speeding tickets. However, variables, such as the conditions and settings in which the devices are used, vary from location to location and thus, may hinder the effectiveness of the device. Additionally, the method of detection and detection conditions utilized also vary from location to location. For example, a location with many mountains or tunnels may affect the devices ability to detect radar or laser signals, while locations absent of these obstacles may result in an increase of “false alarms.”

Therefore, what is needed is a system which can adjust, in real time, the detection settings, detection methods, or any device parameter based upon the location of the device. In particular, what is needed is a radar and laser detection or disruption device, utilizing location information stored in its memory, which can look up the optimal device settings for a given location and automatically adjust the device settings accordingly. Alternatively, what is needed is a device which can retrieve optimal device settings information in real time based upon or in combination with location information.

### SUMMARY OF THE INVENTION

This summary is provided to introduce concepts in a simplified form that are further described in the detailed description of the invention. This summary is not intended to provide or identify all key or essential inventive concepts of the claimed subject matter, nor is it intended for determining the scope of the claimed subject matter.

The object of the present invention is to provide a user-friendly device that automatically calibrates its settings according to the location of the device so that it can provide optimal effectiveness for that particular location. The present invention provides a radar and laser detector and disruption device which can adjust the detection settings, detection methods, or any device parameters in real time based upon the location of the device. In particular, the present invention can identify its location, look up the optimal device settings for that location, and then automatically adjust the device settings to optimize detection and/or disruption of radar and/or laser detection or disruption signals.

In order to achieve this objective, the CPU of the device is designed to change one or more settings of the device in response to the location information of the device. In this way the functioning of the device can be adapted to local conditions, such as the local laws (i.e., whether or not detection or jamming of radar or laser measurements is permitted in a jurisdiction or location), the type of radar and/or laser measurement equipment most often used, or the local physical conditions (i.e., the presence or absence of mountains or buildings, which can influence the (desired) functioning of the device). Based on the location information, the desired settings of the device are retrieved from a database stored the device's memory and the system is adjusted.

In a first preferred embodiment of the invention, one setting of the device that can be changed in response to the location information that is received, in combination with the device feature designed to detect signals at several frequencies, bands, bandwidths and/or scan speed of the band, comprises the frequencies at which scanning takes place with regards to the bands and/or bandwidths.

In another preferred embodiment of the invention, one setting of the device that can be changed in response to location information, in combination with the device feature designed to detect signals at several frequencies, bands, bandwidths and/or scan speed of the band, comprises the frequencies at which alarm signals are delivered with regards to the bands and/or bandwidths of the received signals.

In another preferred embodiment of the invention, one setting of the device that is changed in response to the location information, in combination with the device feature which utilizes a radar or laser jammer for delivering radar or laser interference signals, wherein the device is designed for performing several types of radar or laser jamming, comprises the type of radar or laser jamming performed by the device.

In another preferred embodiment of the invention, one setting of the device that is changed in response to the location information, in combination with the device feature designed to communicate with other devices in the area via radar or laser signals, comprises the type of radar or laser signals being transmitted. The other devices may be present in vehicles that are within the vicinity.

In another preferred embodiment of the invention, one setting of the device that can be changed in response to the location information, in combination with the feature that can change detection sensitivity settings, such as the duration and the frequency of the scanning intervals and/or the detection threshold, comprises the detection sensitivity settings.

In another preferred embodiment of the invention, one setting of the device that can be changed in response to the location information that is received, in combination with the device feature designed for determining, with a certain degree of probability, whether or not a signal comes from speed measurement equipment and, thus requires an alarm signal in response thereto, comprises the alarm sensitivity setting which, with a higher or lower degree of probability, determines whether or not signals come from speed measurement equipment. This determination is based on whether the sensitivity setting for the number of alarm signals to be delivered or suppressed is increased or decreased.

In another preferred embodiment of the invention, one setting of the device that is changed in response to the location information that is received comprises the turning on or off of detection or interference functions of the device, such as radar detection, laser detection or laser jamming.

The preceding preferred embodiments are concerned with the problem that different measuring equipment is used in different jurisdictions, or even in sectors within jurisdictions, so that the device is preferably adapted to detect as many different types of measuring equipment as possible. As a result, the device may generate many unnecessary false alarms. Selectively and automatically adapting the operation of the device to the local conditions enables the device to function optimally.

In another preferred embodiment of the invention, one setting of the device that is changed in response to the location information that is received comprises the deletion of software from the device's memory that performs a detection or interference function, such as radar detection, laser detection or laser jamming.

In another preferred embodiment of the invention, one setting of the device that is changed in response to the location information that is received, in combination with the device feature that contains mobile data communication means, comprises the downloading and installation of software in the device's memory that performs a detection or interference function, such as radar detection, laser detection, laser jamming.

The preceding three preferred embodiments are concerned with the problem that results from legislation concerning this subject strongly varying by jurisdiction. The user must therefore be well aware of what is and what is not allowed, and needs to have the ability to change the use of the device accordingly when travelling between different jurisdictions. The invention automatically takes care of this for the user; the functions of the device are adapted in accordance with local legislation as soon as the border between two jurisdictions is crossed.

In another preferred embodiment of the invention, one setting of the device that is changed in response to the location information that is received, in combination with the device feature designed to alert the user if a stretch follows where location determination is not possible, such as a tunnel, comprises turning on or off the generation of an alert that a stretch follows where location determination is not possible.

This solves the problem that alarm signals are repeatedly delivered in areas where there are many tunnels. The user travelling in such areas knows, however, that location determination is not possible in tunnels and need not be alerted to this at every tunnel, or at least only once. In areas where tunnels are located far apart, it may be desirable to provide an alert for every tunnel.

In another preferred embodiment of the invention, one setting of the device that is changed in response to the location information that is received, in combination with the user interface feature designed to communicate to the user an indication of the type of radar or laser signal that is received or the equipment that emitted the received signal, which indication is selected from collections of indications of types or radar or laser signals or equipment that emits such signals, comprises the collection of indications of types or radar or laser signals or equipment that emits said signals, which is used by the CPU.

The present invention solves the problem that different types of equipment are used in different areas, which in some cases deliver the same type of signals. For the user it may be beneficial to see an image of the detected equipment on a display screen. Using different collections of images of the equipment that is locally used in different areas reduces the risk of the wrong image being displayed.

In another preferred embodiment of the invention, one setting of the device that is changed in response to the location information, in combination with the audio alarm signal, comprises the sound level of the alarm signal. This setting is preferably automatically set once, the first time the device is started. It has been found that, on average, users in different countries have different preferences as to the sound level of such devices.

In another preferred embodiment of the invention, one setting of the device that is changed in response to the location information that is received, in combination with a user interface feature, such as a display screen and/or a loudspeaker, designed to communicate with the user is several languages, comprises the language in which the user interface communicates with the user. Preferably, this setting is automatically set once, the first time the device is started. The language generally spoken in the area where the device is first used by the user automatically becomes the default language.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 is a schematic block diagram of a device for alerting to and/or preventing radar and/or laser measurements according to the present invention.

### DETAILED DESCRIPTION OF EXEMPLARY EMBODIMENTS

Particular embodiments of the present invention will now be described in greater detail with reference to the figures.

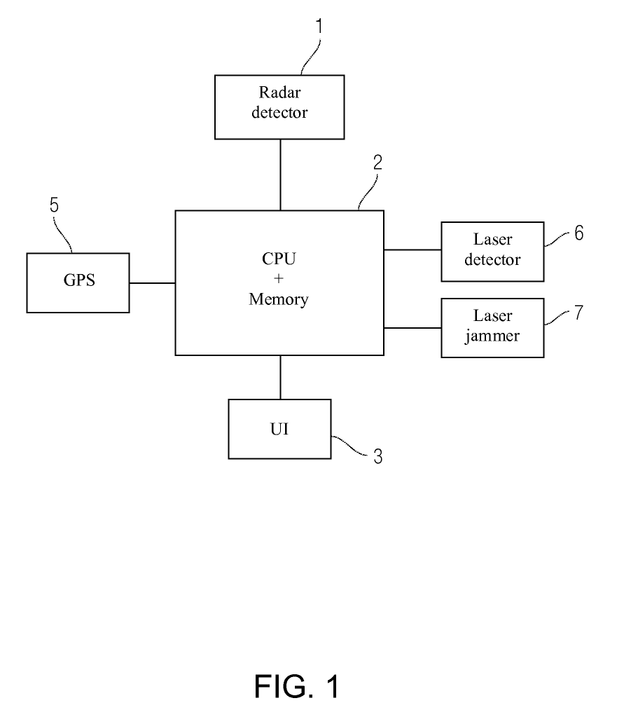

According to FIG. 1, a device for alerting to and/or preventing radar and/or laser measurements comprises a radar detection antenna 1, a central processing unit 2 provided with a digital signal processing unit, which is connected to the radar detection antenna 1. The device further comprises a laser detection sensor 6 and a laser jammer 7 capable of transmitting laser jamming pulses, both of which are connected to the central processing unit 2. The device further comprises a user interface 3, which is connected to the central processing unit 2. The user interface 3 comprises a display screen and a loudspeaker that function as an alerting device capable of delivering an audio and/or visual alarm signal. The user interface may also be used for sharing other information with the user.

The central processing unit 2 can be loaded with a computer program designed for determining characteristics of a radar signal received by the radar detection antenna 1 and delivers an alarm signal based on said characteristics. The central processing unit 2 (“CPU”) may further be loaded with a computer program designed to detect laser pulses by means of the laser detector 6 and deliver, via the laser jammer 7, laser jamming pulses based on said detection. All information regarding the device settings is initially transferred to the CPU 2 so that the processor can determine what to do with the information. The CPU 2 along with the other units can be fully integrated and housed in one unit or it can be one main unit connected to one or more peripheral units. In the latter configuration, some information is kept local in the CPU 2 and some of the information transfers to the peripheral units. Although FIG. 1 depicts the CPU 2 and Memory as one unit, the memory could be integrated into the CPU 2 or connected to the CPU 2.

The device or system of the present invention provides a user-friendly radar and laser detector and jammer which can automatically calibrate one or more settings of the device according to the location of the device. Based upon location information from the GPS 5, the CPU 2 determines the optimal settings for the device and adjusts the settings for the radar detector 1, laser detector 6, laser jammer 7, and the user interface 3. In the preferred embodiment, the CPU 2 determines the settings through a lookup table or database stored on the memory. Memory can be integrated into the CPU 2, a memory unit connected to the CPU 2, or an external memory device, such as a microSD card which can be connected to the CPU 2.

If the settings tables need to be updated with new setting information, the system can be plugged into a personal computer or laptop via a USB cable where it can download and then update the table. An update could also be installed into the system through microSD card.

In another embodiment, the optimal settings can be transmitted to the system remotely or wireless. This can be done through a general packet radio service (GPRS) integrated within the system or an external device with GPRS capabilities or through WiFi or other similar technology. The system can also connect to an external device, such as a smartphone, through USB cable or Apple® cable, or wirelessly through Bluetooth or similar technology. Through GPRS, WiFi, or the external device the system would receive information regarding new optimal settings based on its location. The optimal settings information received could either update the system's table, change the settings without a table look up or could update the whole system or part of the system instead of changing a specific setting. Once the optimal settings are identified, the CPU 2 automatically changes one or more settings of the device.

Alternatively, the system could receive the optimal settings information for the device in combination or in response to the location information from the GPS 5. More specifically, the GPS unit 5 can transmit and receive information about its location including receiving information about the optimal settings. The transmission of receipt of such information need not be through the GPS unit 5 and could be from the other units which can transmit and receive signals including the radar and laser transmitters and detectors 1, 6.

As for specific setting alterations, the system can identify its location through the GPS unit 5, look up the optimal device settings in the memory for that location, and then automatically adjust the device settings to optimize detection and/or disruption of radar and/or laser detection or disruption signals through the radar detector 1, laser detector 6, or laser jammer 7.

By adjusting the settings, the functioning of the device can be adapted to local conditions and laws (i.e., whether or not detection or jamming of radar or laser measurements is permitted in a jurisdiction or location), the type of radar and/or laser measurement equipment most often used, or the local physical conditions (i.e., the presence or absence of mountains or buildings, which can influence the (desired) functioning of the device). Based on the location information determined by the GPS unit 5, the desired settings of the device are retrieved from a database stored the device's memory and the system's settings are adjusted.

One of the settings that can be changed in response to the location information from the GPS unit 5 is the frequency with which scanning takes place with regards to the bands and/or bandwidths of the radar detector 1. Specifically, based upon location, the CPU 2 will adjust the settings of the radar detector unit 1 (or laser detector unit 6) and adjust frequency of the bands, the bandwidth with which scanning takes place and/or the scan speed of the band.

One of the settings that can be changed in response to the location information from the GPS unit 5 is the frequency with which alarm signals are delivered by radar detector 1 with regards to the bands and/or bandwidths. Specifically, based upon location, the CPU 2 will adjust the settings of the radar detector unit 1 (or laser detector unit 6) and adjust frequency of the bands, the bandwidths and/or the scan speed of the band.

One of the settings that can be changed in response to the location information from the GPS unit 5 is the type of radar or laser jamming performed by the device. Specifically, based upon location, the CPU 2 will adjust the settings of the radar jammer, which is not depicted in FIG. 1 but is included in the radar detector unit 1, or laser jammer unit 7. The jammer 7 delivers radar or laser interference signals in order to perform several types of radar or laser jamming. Adjustments to the laser jammer settings can occur by varying the light frequency, power output or intensity of the jammer, and pulse rate.

One of the settings that can be changed in response to the location information from the GPS unit 5 is the type of radar or laser signals being transmitted. Specifically, based upon location, the CPU 2 will adjust the settings of the device feature designed to communicate with other devices in the area via radar or laser signals. The other devices may be present in vehicles that are within the vicinity.

One of the settings that can be changed in response to the location information from the GPS unit 5 is the detection sensitivity settings. Specifically, based upon location, the CPU 2 will adjust the settings of the radar detector unit 1 or laser detector unit 6 by changing the duration and the frequency of the scanning intervals and/or the detection threshold.

One of the settings that can be changed in response to the location information from the GPS unit 5 is the alarm sensitivity setting. This setting, with a higher or lower degree of probability, determines whether or not signals come from speed measurement equipment. This determination is based on whether the sensitivity setting for the number of alarm signals to be delivered or suppressed is increased or decreased. Specifically, based upon location, the CPU will adjust the settings of the radar detector unit 1 or laser detector unit 6 which are designed for determining, with a certain degree of probability, whether or not a signal comes from speed measurement equipment and, thus requiring an alarm signal in response thereto.

One of the settings that can be changed in response to the location information from the GPS unit 5 is the ability to turn on or off of detection or interference functions of the device, such as radar detection, laser detection or laser jamming. Specifically, based upon location, the CPU 2 will adjust the settings to turn on or off the radar detector unit 1, laser detector unit 6, or laser jammer unit 7.

The preceding preferred embodiments are concerned with the problem that different measuring equipment is used in different jurisdictions, or even in sectors within jurisdictions, so that the device is preferably adapted to detect as many different types of measuring equipment as possible. As a result, the device may generate many unnecessary false alarms. Selectively and automatically adapting the operation of the device to the local conditions enables the device to function optimally.

One of the settings that can be changed in response to the location information from the GPS unit 5 is the deletion of software from the device's memory unit that performs a detection or interference function, such as radar detection, laser detection or laser jamming.

One of the settings that can be changed in response to the location information from the GPS unit 5 is the downloading and installation of software in the device's memory unit 2 that performs a detection or interference function, such as radar detection, laser detection, laser jamming. Specifically, based upon location, the CPU 2 will adjust the settings of the device feature that contains mobile data communication unit or means. The communication unit is capable of connecting with one or more networks or servers and downloading appropriate software for the unit. In an exemplary embodiment, this is accomplished through Wi-Fi or through a general packet radio service (GPRS) receiver integrated within the system or an external device with GPRS capabilities. The present invention can also be configured to connect to anexternal device, such as a smartphone, through USB cable or Apple® cable, or wirelessly through Bluetooth or similar technology. Through GPRS, Wi-Fi, or through a wireless phone, the device would receive new software based on its location, and subsequently update the system accordingly. The software can then be installed to the device's memory for operating the detection or interference functions of the device. The preceding three preferred embodiments are concerned with the problem that results from laws regulating radar and laser detection and jamming varying by jurisdiction. The user must therefore be well aware of what is and what is not allowed within each jurisdiction, and needs to have the ability to change the use of the device accordingly when travelling between different jurisdictions. The present invention automatically handles conformance with local jurisdictions for the user by altering the functions of the device to be adapted or configured to be in accordance with local legislation as soon as the border between two jurisdictions is crossed. The device determines its location or crossing between jurisdictions based on the GPS unit 5.

One of the settings that can be changed in response to the location information from the GPS unit 5 is the turning on or off of the generation of an alert and/or alarm in a location where determination is not possible. Specifically, based upon location, the CPU 2 will adjust the settings of the user interface unit 3 which is designed to alert the user if a jurisdiction or location is entered where location determination is not possible (i.e., a tunnel).

This solves the problem that alarm signals are repeatedly delivered in areas where there are many tunnels. The user travelling in such areas knows, however, that location determination is not possible in tunnels and need not be alerted to this at every tunnel, or at least only once. In areas where tunnels are located far apart, it may be desirable to provide an alert for every tunnel.

Another setting that can be changed in response to the location information from the GPS unit 5 is the collection of indications of the types of radar or laser signals or equipment that emits said signals, which is used by the CPU 2. Specifically, based upon location, the CPU 2 will adjust the settings of the user interface unit 3 which is designed to communicate to the user an indication of the type of radar or laser signal that is received or the equipment that emitted the received signal. This indication is selected from collections of indications of types or radar or laser signals or equipment that emits such signals stored in the devices memory unit.

The present invention also solves the problem that different types of speed detection equipment are used in different areas, which in some cases deliver the same type of signals. For the user it may be beneficial to see an image of the speed detection equipment on a display screen. Using different collections of images of the equipment that is used in different areas or jurisdictions reduces the risk of the wrong image being displayed.

One of the settings that can be changed in response to the location information from the GPS unit 5 is the sound level of the alarm signal. Specifically, based upon location, the CPU 2 will adjust the settings of the user interface unit's 3 audio alarm signal feature. This setting is preferably set once automatically the first time the device is started. It has been found that, on average, users in different countries or jurisdictions have different preferences as to the sound level of such devices.

Another setting that can be changed in response to the location information from the GPS unit 5 is the language in which the user interface unit 3 communicates with the user. Specifically, based upon location, the CPU 2 can adjust the language used by both the user interface unit's 3 display screen and/or a loudspeaker designed to communicate with the user. Preferably, this setting is automatically set once the first time the device is started. The language generally spoken in the area where the device is first used by the user automatically becomes the default language.

The examples provided herein are merely for the purpose of explanation and are in no way to be construed as limiting the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood, therefore, that the invention is not limited to the particular embodiment which is described, but is intended to cover all modifications and changes within the scope and spirit of the invention.

What is claimed is:

1. A radar detection device, comprising:
a central processing unit;
a radar detection unit connected to the central processing unit; and
a location determination unit connected to the central processing unit which provides location information to the central processing unit, the central processing unit changing at least one setting of the device in response to the location information.

2. The device of claim 1, wherein the at least one setting of the device which may be changed may be comprised of one or more of the following:
the frequency at which scanning takes place; the bands at which scanning takes place, the bandwidths at which scanning takes place; the frequency of a received signal at which an alarm signal is delivered; the bands of a received signal at which an alarm signal is delivered, the bandwidths of a received signal at which an alarm signal is delivered; the type of radar signals being transmitted; the detection sensitivity; the duration of scanning intervals, the frequency of scanning intervals, the detection threshold; the alarm sensitivity; the turning on or off of the radar detection unit; the deletion of software from a memory unit connected to the central processing unit; the installation of software to the memory unit; the turning on or off of the generation of an alert unit; the turning on or off the indication of the type of radar signal that is received; the turning on or off of the indication of the equipment that emitted the received signal; the sound level of the alarm signal; or the language in which the user interface communicates with the user.

3. The device of claim 1, wherein at least one setting of the device which may be changed in response to the location information is the type of radar signals being transmitted.

4. The device of claim 1, wherein at least one setting of the device which may be changed in response to the location information is the detection sensitivity settings.

5. The device of claim 4, wherein the at least one detection sensitivity settings is comprised of at least one of the following:
the direction of the radar detection unit; the frequency of scanning intervals performed by the radar detection unit; or the detection threshold of the radar detection unit.

6. The device of claim 1, wherein at least one setting of the device which may be changed in response to the location information is the alarm sensitivity.

7. The device of claim 1, wherein at least one setting of the device which may be changed in response to the location information is the turning of the radar detection unit on or off.

8. The device of claim 1, wherein at least one setting of the device which may be changed in response to the location information is the deleting of software from the memory.

9. The device of claim 1, wherein at least one setting of the device which may be changed in response to the location information is the installing of software.

10. The device of claim 1, wherein at least one setting of the device which may be changed in response to the location information is the turning on or off the generation of an alert unit.

11. The device of claim 1, wherein at least one setting of the device which may be changed in response to the location information is the turning on or off the indication of the type of radar signal that is received.

12. The device of claim 1, wherein at least one setting of the device which may be changed in response to the location information is the turning on or off of the indication of the equipment that emitted the received signal.

13. The device of claim 1, wherein at least one setting of the device which may be changed in response to the location information is the sound level of the alarm signal.

14. The device of claim 1, wherein at least one setting of the device which may be changed in response to the location information is the language in which the user interface communicates with the user.

15. A laser detection device, comprising:
a central processing unit;
a laser detection unit connected to the central processing unit; and
a location determination unit connected to the central processing unit which provides location information to the central processing unit, the central processing unit changing at least one setting of the device in response to the location information.

16. The device of claim 15, wherein the at least one setting of the device which may be changed may be comprised of one or more of the following:
the frequency at which scanning takes place; the bands at which scanning takes place, the bandwidths at which scanning takes place; the frequency of a received signal at which an alarm signal is delivered; the bands of a received signal at which an alarm signal is delivered, the bandwidths of a received signal at which an alarm signal is delivered; the type of laser signals being transmitted; the detection sensitivity; the duration of scanning intervals, the frequency of scanning intervals, the detection threshold; the alarm sensitivity; the turning on or off of the laser detection unit; the deletion of software from a memory unit connected to the central processing unit; the installation of software to the memory unit; the turning on or off the generation of an alert unit; the turning on or off the indication of the type of laser signal that is received; the turning on or off of the indication of the equipment that emitted the received signal; the sound level of the alarm signal; the language in which the user interface communicates with the user.

17. The device of claim 15, wherein the at least one setting of the device which may be changed in response to the location information is the type of laser signals being transmitted.

18. The device of claim 15, wherein the at least one setting of the device which may be changed in response to the location information is the detection sensitivity settings.

19. The device of claim 18, wherein the at least one detection sensitivity settings is comprised of at least one of the following:
the direction of the laser detection unit; the frequency of scanning intervals performed by the laser detection unit; or the detection threshold of the laser detection unit.

20. The device of claim 15, wherein the at least one setting of the device which may be changed in response to the location information is the alarm sensitivity.

21. The device of claim 15, wherein the at least one setting of the device which may be changed in response to the location information is the turning of the laser detection unit on or off.

22. The device of claim 15, wherein the at least one setting of the device which may be changed in response to the location information is the deleting of software from the memory.

23. The device of claim 15, wherein the at least one setting of the device which may be changed in response to the location information is the installing of software to the memory.

24. The device of claim 15, wherein the at least one setting of the device which may be changed in response to the location information is the turning on or off the generation of an alert unit.

25. The device of claim 15, wherein the at least one setting of the device which may be changed in response to the location information is the turning on or off of the indication of the type of laser signal.

26. The device of claim 15, wherein the at least one setting of the device which may be changed in response to the location information is the turning on or off of the indication of the equipment that emitted the received signal.

27. The device of claim 15, wherein the at least one setting of the device which may be changed in response to the location information is the sound level of the alarm signal.

28. The device of claim 15, wherein the at least one setting of the device which may be changed in response to the location information is the language in which the user interface communicates with the user.

29. A radar jamming device, comprising:
a central processing unit;
a radar detection unit connected to the central processing unit;
a radar jamming unit connected to the central processing unit; and
a location determination unit connected to the central processing unit which provides location information to the central processing unit, the central processing unit changing at least one setting of the device in response to the location information.

30. The device of claim 29, wherein the at least one setting of the device which may be changed may be comprised of one or more of the following:
the frequency at which scanning takes place; the bands at which scanning takes place, the bandwidths at which scanning takes place; the frequency of a received signal at which an alarm signal is delivered; the bands of a received signal at which an alarm signal is delivered, the bandwidths of a received signal at which an alarm signal is delivered; the type of radar jamming; the type of radar signals being transmitted; the detection sensitivity; the duration of scanning intervals, the frequency of scanning intervals, the detection threshold; the alarm sensitivity; the turning on or off of the radar detection unit; the turning on or off of the radar jamming unit; the deletion of software from a memory unit connected to the central processing unit; the installation of software to the memory unit; the turning on or off the generation of an alert unit; the turning on or off the indication of the type of radar signal that is received; the turning on or off of the indication of the equipment that emitted the received signal; the sound level of the alarm signal; the language in which the user interface communicates with the user.

31. The device of claim 29, wherein the at least one setting of the device which may be changed in response to the location information is the type of radar jamming performed by the device.

32. The device of claim 29, wherein the at least one setting of the device which may be changed in response to the location information is the turning of the radar jamming unit on or off.

33. The device of claim 29, wherein the at least one setting of the device which may be changed in response to the location information is the deleting software from the memory.

34. The device of claim 29, wherein the at least one setting of the device which may be changed in response to the location information is the installing software to the memory.

35. The device of claim 29, wherein the at least one setting of the device which may be changed in response to the location information is turning on or off the generation of an alert unit.

36. The device of claim 29, wherein the at least one setting of the device which may be changed in response to the location information is the turning on or off of the indication of the type of radar signal that is received.

37. The device of claim 29, wherein the at least one setting of the device which may be changed in response to the location information is the turning on or off of the indication of the equipment that emitted the received signal.

38. The device of claim 29, wherein the at least one setting of the device which may be changed in response to the location information is the sound level of the alarm signal.

39. The device of claim 29, wherein the at least one setting of the device which may be changed in response to the location information is the language in which the user interface communicates with the user.

40. A laser jamming device, comprising:
a central processing unit;
a laser detection unit connected to the central processing unit;
a laser jamming unit connected to the central processing unit; and
a location determination unit connected to the central processing unit which provides location information to the central processing unit, the central processing unit changing at least one setting of the device in response to the location information .

41. The device of claim 40, wherein the at least one setting of the device which may be changed may be comprised of one or more of the following:
the frequency at which scanning takes place; the bands at which scanning takes place, the bandwidths at which scanning takes place; the frequency of a received signal at which an alarm signal is delivered; the bands of a received signal at which an alarm signal is delivered, the bandwidths of a received signal at which an alarm signal is delivered; the type of laser jamming; the type of laser signals being transmitted; the detection sensitivity; the duration of scanning intervals, the frequency of scanning intervals, the detection threshold; the alarm sensitivity; the turning on or off of the laser detection unit; the turning on or off of the laser jamming unit; the deletion of software from a memory unit connected to the central processing unit; the installation of software to the memory unit; the turning on or off the generation of an alert unit; the turning on or off the indication of the type of laser signal that is received; the turning on or off of the indication of the equipment that emitted the received signal; the sound level of the alarm signal; the language in which the user interface communicates with the user.

42. The device of claim 40, wherein the at least one setting of the device which may be changed in response to the location information is the type of laser jamming performed by the device.

43. The device of claim 40, wherein the at least one setting of the device which may be changed in response to the location information is the turning of the laser jamming unit on or off.

44. The device of claim 40, wherein the at least one setting of the device which may be changed in response to the location information is the deleting software from the memory.

45. The device of claim 40, wherein the at least one setting of the device which may be changed in response to the location information is the installing software to the memory.

46. The device of claim 40, wherein the at least one setting of the device which may be changed in response to the location information is turning on or off the generation of an alert unit.

47. The device of claim 40, wherein the at least one setting of the device which may be changed in response to the location information is the turning on or off of the indication of the type of laser signal that is received.

48. The device of claim 40, wherein the at least one setting of the device which may be changed in response to the location information is the turning on or off of the indication of the equipment that emitted the received signal.

49. The device of claim 40, wherein the at least one setting of the device which may be changed in response to the location information is the sound level of the alarm signal.

50. The device of claim 40, wherein the at least one setting of the device which may be changed in response to the location information is the language in which the user interface communicates with the user.

51. A method for changing the settings of a detector device based upon location information comprising the steps of:
receiving location information of the location of the device;
obtaining at least one preferred setting for the device based upon the location information; and
changing at least one device setting based upon the at least one preferred setting.

52. The method of claim 51, wherein the at least one preferred setting may be comprised of one or more of the following:
the frequency bandwidth; type of radar jamming; the type of laser jamming; the type of radar signal being transmitted; the detection sensitivity; the alarm sensitivity; the functioning of the detection function; the functioning of the interference function; the sound level of the alarm signal; or the language of the device.

53. A method for changing the functions of a detector device based upon location information comprising the steps of:
receiving location information of the location of the device;
obtaining restriction information on at least one restricted function of the device based upon the location information; and
disabling at least one function of the device based upon the at least one restricted function information.

54. The method of claim 53, wherein the step of obtaining restriction information includes the step of retrieving the restriction information from a table stored in memory on the device.

55. The method of claim 53, wherein the step of obtaining restriction information includes the step of retrieving the restriction information from a network.

56. The method of claim 53, wherein the step of disabling at least one function includes one of the following steps:
deleting software from the device; disabling at least one signal detection unit;
or disabling at least one signal jamming unit.

57. A method for changing the functions of a detector device based upon location information comprising the steps of:
receiving location information of the location of the device;
obtaining permitted function information on at least one permissible function of the device based upon the location information; and
enabling at least one function of the device based upon the at least one permissible function information.

58. The method of claim 57, wherein the step of obtaining permitted information includes the step of retrieving the information from a table stored in memory on the device.

59. The method of claim 57, wherein the step of obtaining permitted information includes the step of retrieving the information from a network.

60. The method of claim 57, wherein the step of enabling at least one function includes one of the following steps:
installing software on the device; enabling at least one signal detection unit;
enabling at least one signal jamming unit;
